(19) United States
(12) Patent Application Publication
(10) Pub. No.: US 2010/0000151 A1
(43) Pub. Date: Jan. 7, 2010

(54) Wall surface greening system

(75) Inventors: Tomihisa Kato, Nagoya-shi (JP); Takao Hoshiya, Nagoya-shi (JP)

Correspondence Address: MORGAN LEWIS & BOCKIUS LLP, 1111 PENNSYLVANIA AVENUE NW, WASHINGTON, DC, 20004, US

(73) Assignee: Asahi Intecc Co., Ltd.

(21) Appl. No.: 12/585,234

(22) Filed: Sep. 9, 2009

Related U.S. Application Data
(62) Division of application No. 11/798,722, filed on May 16, 2007.

(30) Foreign Application Priority Data
May 19, 2006 (JP) 2006-139791

(51) Int. Cl. A01G 1/00

(52) U.S. Cl. 47/47

(57) ABSTRACT

A wall surface greening system in which ropes are provided on a surface wall. Each of the ropes has a core rope, around which a side rope is wound in a longitudinal direction of the core rope so as to grow a twiner of liana. A plurality of ropes are arranged in a stretched condition to form a diamond cross pattern as a whole.

The present patent application is a divisional patent application derived from the patent application Ser. No. 11/798,722 filed on May 16, 2007, a part of which is incorporated into the present invention.

### BACKGROUND OF THE INVENTION

1. Field of the Invention

The present invention relates to a wall surface greening system made by using the spiral rope.

2. Description of the Related Art

As a spiral rope of this kind, there is, conventionally, a rope adopted in a wall surface greening technology and a wire stretching device disclosed in Japanese Laid-Open Patent Publication No. 2006-36.

In the conventional spiral rope, a wire member, which is formed by a metallic core member with a resin coated, is spirally wound around a wire main body that is formed with steel wires twisted up together and is coated with a resin.

However, the rope, which is adopted in the wall surface greening technology and the wire stretching device, has merely the above-mentioned spirally wound construction.

Therefore, in applying the wire stretching device to a liana, a twiner of the liana is hard to smoothly wind around the rope and may be detached from the rope, if the steel wires are wound around the wire main body toward a direction that does not match the winding feature of the twiner according to growth of the liana.

Furthermore, the appearance deteriorates, if the color tone of the outer surface of the rope does not match the color tone of the surroundings of the rope such as the liana.

### SUMMARY OF THE INVENTION

It is therefore an object of the present invention to provide a spiral rope for liana raising, which is suitable for the growth features of a liana.

It is another object of the present invention to provide a manufacturing method for the spiral rope.

It is further an object of the present invention to provide a wall surface greening system using the spiral rope.

To achieve these objects, the present invention provides a spiral rope for liana raising that comprises a core member formed from austenite-based stainless steel twisted wires, and a side member formed from austenite-based stainless steel twisted wires, and a side member formed fro austenite-based stainless steel twisted wires. The side member is spirally wound around the core member at intervals in a direction along a winding direction of a twiner of the liana.

Thus, the winding direction of the side member around the core member is coincided with the winding direction of the twiner of the liana. Therefore, the winding direction of the side member around the core member is a counter-clockwise direction when seen from the top end portion of the twiner of the liana along its growth, if the winding direction of the twiner of the liana is the counter-clockwise direction. Accordingly, spiral grooves are formed around the outer periphery of the spiral rope so as to coincide with the counter-clockwise direction.

On the other hand, the winding direction of the side member around the core member is a clockwise direction when seen from the top end portion of the twiner of the liana along its growth, if the winding direction of the twiner of the liana is the clockwise direction. Accordingly, spiral grooves are formed around the outer periphery of the spiral rope so as to coincide with the clockwise direction.

As a result, regardless whether the winding direction of the twiner of the liana is in the counter-clockwise direction or the clockwise direction, the liana may grow up while extending its twiner along the spiral grooves of the rope and smoothly winding the twiner around the core member.

As described above, the material constituting the core member and the side member is an austenite-based stainless steel twisted wire. Thus, the thermal conductivity of the austenite-based stainless steel twisted wire is as low as about a half of that of common carbon steel. Therefore, the twisted wire is hard to be heated and hard to be cooled.

Furthermore, the core member and the side member are made of twisted wires, as described above. Thus, the core member and the side member have increased surface areas. Accordingly, the twisted wires made of austenite-based stainless steel promote heat radiation of the spiral ropes when the irradiation of sunshine is strong in summer. As a result, the liana may be satisfactorily prevented from discoloration by heat.

In an aspect of the present invention, the core coating body and the side coating body, which coat the core member and the side member, are made of an identical or same kind of resin material with each other.

Therefore, an adhesion phenomenon occurs between the core coating body and the side coating body wound around the core coating body, thereby being incapable of slipping between the core coating body and the side coating body.

As a result, deviation of the side member from the core member may be assuredly prevented in a state where the side member coated with the side coating body is wound around the core member coated with the core coating body.

In another aspect of the present invention, at least one of the core coating body and the side coating body is made of a resin material that is obtained by adding to an identical or same kind of resin material. The resin material imparts a color tone capable of assimilating with the color tone of the liana.

Thus, at least one of the core coating body and the side coating body is assimilated with the color tone of the liana. As a result, a unique effect can be achieved that at least one of the core coating body and the side coating body is not conspicuous against the liana. Also, a wall surface greening system can be maintained in a good appearance when the spiral rope having such a unique effect is adopted to the wall surface greening system.

Still another aspect of the present invention, at least one of the core coating body and the side coating body is made of a material that is obtained by adding to an identical or same kind of resin material. The resin material imparts a color tone capable of achieving complementary color contrast with respect to the color tone of the liana.

Thus, the color tone of at least one of the core coating body and the side coating body is in a complementary color contrast relationship with the color tone of the liana. As a result, at least one of the core coating body and the side coating body is not conspicuous against the liana. In addition, the wall surface greening system may be maintained in a good appearance when the spiral ropes is adopted thereto.

In a further aspect of the present invention, the twisted direction of each element wire as a twisted wire of the side strand creates a predetermined cross angle with respect to the twisting direction of each element wire as a twisted wire of the core strand. Accordingly, a so-called anchor effect occurs between the side strand and the core strand.

Thus, a strong engagement of the side strand to the core strand is created to assuredly prevent the deviation in the winding position of the side strand from the core strand.

A still further aspect of the present invention, the twisting direction of each element wire as a twisted wire of one or a plurality of bundles of side strands creates a predetermined cross angle with respect to the twisting direction of each element wire as a twisted wire of the core strand. Accordingly, a so-called anchor effect occurs between one or a plurality of bundles of side strands described above and the core strand.

As a result, a strong engagement of one or a plurality of side strands to the core strand is created to assuredly prevent the deviation in the winding position of one or a plurality of bundles of side strands from the core strand.

In another aspect of the present invention, the core rope member includes a core strand constituted by a plurality of bundles of austenite-based stainless steel twisted wires, and a plurality of bundles of side strands each constituted by twisting a plurality of bundles of strands formed from austenite-based stainless steel twisted wires. And, the side rope member is a strand formed from austenite-based stainless steel twisted wires.

Here, with the core rope member and the side rope member constructed as described above, the winding direction of the side rope member around the core rope member is coincided with the winding direction of the twiner of the liana.

In still another aspect of the present invention, the twisting direction of each element wire as a twisted wire of the strand or the side rope member creates a predetermined cross angle with respect to the twisting direction of each element wire as a twisted wire of the plurality of bundles of side strands of the core rope member. Accordingly, a so-called anchor effect occurs between the side rope member and the core rope member to create a strong engagement of the side rope member to the core rope member. As a result, the deviation in the winding position of the side rope member is assuredly prevented from the core rope member.

To achieve the above mentioned objects of the present invention, a wall surface greening system includes a plurality of the spiral ropes for liana raising, wherein the plurality of spiral ropes are supported on a wall surface into a predetermined stretching pattern so as to be opposed to the wall surface.

Thus, the wall surface greening system can achieve the above-described effect of the invention even if the predetermined stretching pattern is a diamond cross pattern, a check cross pattern or a stripe pattern.

To achieve the above mentioned objects of the present invention, a manufacturing method for a spiral rope for liana raising comprises the steps of: forming a core coating layer and a side coating layer with an identical or same kind of resin material so as to coat a core member and a side member respectively formed from austenite-based stainless steel twisted wires; and winding the side member around the core member spirally at intervals in a direction along a winding direction of a twiner of a liana, wherein at least one of said core coating layer and the side coating layer is formed to coat at least one of the core member and the side member by means of a first colored resin material for assimilation obtained by mixing a colored resin material having a different molecular structure with the identical or same kind of resin material, or by means of a second colored resin material for assimilation obtained by mixing a colored resin material having a different melt index with the identical or same kind of resin material.

Further, a manufacturing method for a spiral rope for liana raising comprises the steps of: forming a core coating layer and a side coating layer with an identical or same kind of resin material so as to coat a core member and a side member respectively formed from austenite-based stainless steel twisted wires; and winding the side member around the core member spirally at intervals in a direction along a winding direction of a twiner of a liana, wherein at least one of the core coating layer and the side coating layer is formed to coat at least one of the core member and the side member by means of a first colored resin material for complementary color contrast obtained by mixing a colored resin material having a different composition with the identical or same kind of resin material, or by means of a second colored resin material for complementary color contrast obtained by mixing a colored resin material having a different melt index with the identical or same kind of resin material.

### BRIEF DESCRIPTION OF THE DRAWINGS

Other features and advantages of the invention will be apparent from the following description taken in connection with the accompanying drawings, wherein:

FIG. 1 is a front view showing a first preferred embodiment of a wall surface greening system according to the present invention.

FIG. 2 is an enlarged side view partially showing a spiral rope for liana raising of the wall surface greening system of FIG. 1, and a liana growing along the spiral rope.

FIG. 3 is a partial side view showing the spiral rope of FIG. 2.

FIG. 4 is a diagram illustrating a spiral rope structured to suit the winding direction of the lianas that grow in the Northern Hemisphere of the earth.

FIG. 5 is a diagram illustrating a spiral rope constructed to suit the winding direction of the lianas that grow in the Southern Hemisphere of the earth.

FIG. 6 is a schematic perspective view illustrating the state where the Karman vortex street is generated when wind blows to a round bar.

FIG. 7 is a diagram illustrating the regulating function of the spiral rope of FIG. 3.

FIG. 8 is a schematic diagram illustrating the diverting function of the spiral rope in the wall surface greening system of FIG. 1.

FIG. 9 is a partial side view showing an essential portion of a second preferred embodiment of the present invention.

FIG. 10 is an enlarged side view partially showing the spiral rope shown in FIG. 9.

FIG. 11 is a partial side view showing an essential portion of a third preferred embodiment of the present invention.

FIG. 12 is a partial side view showing an essential portion of a fourth preferred embodiment of the present invention.

FIG. 13 is a partial side view showing an essential portion of a fifth preferred embodiment of the present invention.

FIG. 14 is a front view of an eighth preferred embodiment of the present invention.

FIG. 15 is a front view of a ninth preferred embodiment of the present invention.

### DETAILED DESCRIPTION OF THE PREFERRED EMBODIMENTS

Hereinafter, preferred embodiments of the present invention will be described with reference to the accompanying drawings.

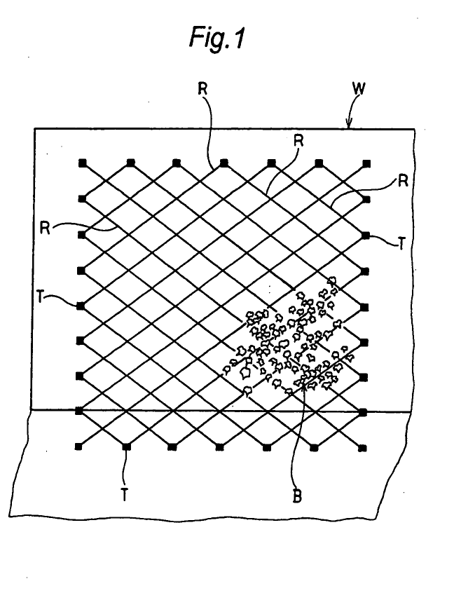

FIG. 1 shows a first preferred embodiment of a wall surface greening system according to the present invention. The wall surface greening system includes a plurality of spiral ropes R for raising lianas.

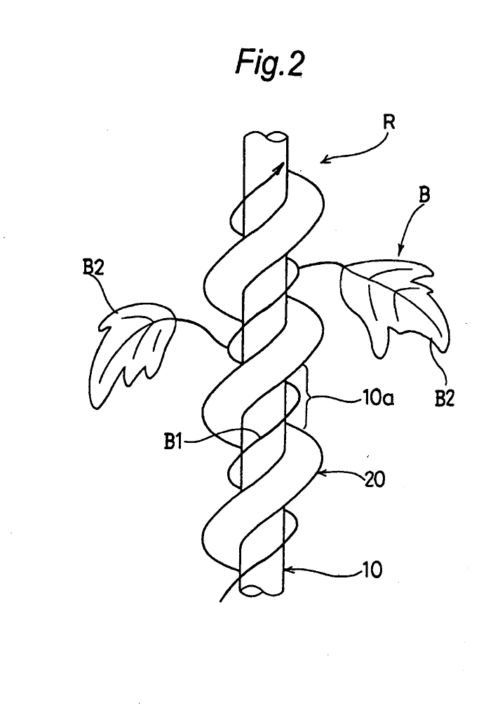

These spiral ropes R are, as shown in FIG. 1, supported by a plurality of tightening metallic fittings T between an upper portion of a wall surface W and the ground. The spiral ropes R are opposed to the wall surface W in an inclined state against the wall surface W with a diamond cross pattern, which is one of predetermined stretching patterns. In the first embodiment, a liana B is, in FIGS. 1 and 2, shown as an example which grows along the wall surface greening system.

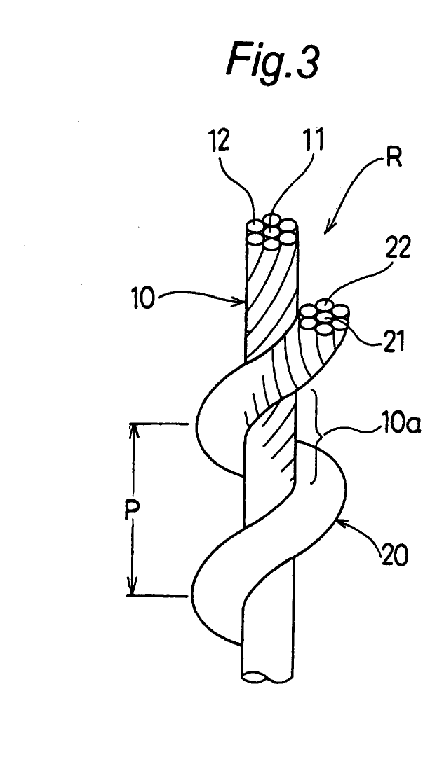

The spiral rope R has, as shown in FIGS. 2 and 3, a core member 10 and a side member 20. The core member 10 is formed as a twisted wire including one core element wire 11, around which 6 or six side element wires 12 are twisted in Z-like shape (see FIG. 3).

The side member 20 is formed as a twisted wire including one core element wire 21, around which 6 or six side element wires 22 are twisted into a S-like shape. The side member 20 is spirally wound around the core member 10 along the longitudinal direction thereof toward a counter-clockwise direction (toward the twisting direction in the form of Z-like shape) at a predetermined winding pitch P (see FIG. 3). Accordingly, grooves 10a are, as shown in FIGS. 2 and 3, formed to be spirally wound in the counter-clockwise direction around an outer periphery of the core member 10 upward in the drawings.

The expression “twisting direction in the form of Z-like shape” means to twist the side element wires 12 around the core element wires 11 into the counter-clockwise direction upward when seen from the above in FIG. 3.

The expression “twisting direction in the form of a S-like shape” means to twist the side element wires 12 around the core element wires 11 into the direction reverse (namely a clockwise direction) of the twisting direction in the form of the Z-like shape.

In addition, the core element wire 21 and the side element wires 22 of the side member 20, as well as the core element wire 11 and the side element wires 12 of the core member 10 are made of austenite-based stainless steel wires (SUS 304).

Herein, will be described the basis of winding the side members 20 around the core member 10 into the counter-clockwise direction.

In order to smoothly raise the liana B along each of the spiral ropes R of the wall surface greening system, it is necessary to match the winding direction of the side members 20 around the core member 10 with the growth feature of a twiner B1 (of FIG. 2) of the liana B. In general, the winding direction of the twiner of the liana differs between the Northern and Southern Hemispheres of the earth. It is believed that this difference results from the centrifugal force based on the rotation of the earth.

Specifically, the twiner of the liana, which grows in the Northern Hemisphere of the earth, grows as it winds in the counter-clockwise direction (in the leftward direction) when seen from its top end side along its growth. On the other hand, the twiner of the liana, which grows in the Southern Hemisphere of the earth, grows as it winds in the clockwise direction (in the rightward direction) when seen from its top end side along its growth.

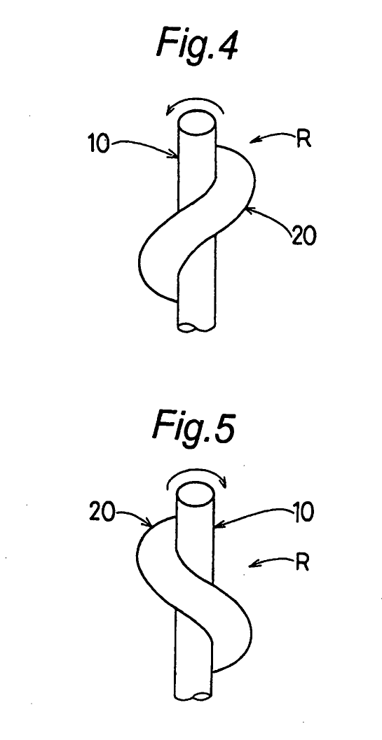

Therefore, in the spiral rope R, it is necessary that as shown by the arrow in FIG. 4, seen from the top of the core member 10, the winding direction of the side member 20 around the core member 10 in the Northern Hemisphere coincides with the winding direction (the above mentioned counter-clockwise direction) of the twiner of the liana that grows in the Northern Hemisphere.

On the other hand, as shown by the arrow in FIG. 5, it is necessary that the winding direction of the side member 20 around the core member 10 in the Southern Hemisphere coincides with the winding direction (the above mentioned clockwise direction) of the twiner of the liana that grows in the Southern Hemisphere.

In the first embodiment, on the assumption that the liana B grows in the Northern Hemisphere, the winding direction of the side member 20 around the core member 10 is, as shown in FIGS. 2 to 4, set to the counter-clockwise direction, seen from the top of the core member 10, so that it coincides with the winding direction (the above described counter-clockwise direction) of the twiner B1 (see FIG. 2) of the liana B.

Further, for forming the spiral rope R in the first embodiment, the predetermined winding pitch P (of FIG. 3) may be arbitrarily set by merely winding the side member 20 around the core member 10 with a proper machine without using a dedicated stranding machine.

When the side member 20 is twisted as a strand around the core member 10 by the dedicated stranding machine, the predetermined winding pitch P is restricted to the stranding pitch determined in accordance with the specification of the stranding machine. For example, if the stranding machine has a specification that twists six (6) side strands together around one core strand, the spiral rope R of the first embodiment is formed by twisting the side member 20 around the core member 10 with five (5) side strands lacked.

According to the first embodiment constructed as described above, the side member 20 is wound around the core member 10 in the counter-clockwise direction (in the twisting direction in the form of the Z-like shape) so as to coincide with the winding direction of the twiner B1 of the liana B that grows in the Northern Hemisphere of the earth. Furthermore, the spiral grooves 10a are formed around the outer periphery of the core member 10 as described above.

Therefore, the liana B may grow in such a manner that the twiner B1 winds around the core member 10 in the clockwise direction along the spiral grooves 10a of the side member 20.

Since the winding direction of the side member 20 around the core member 10 coincides with the winding direction of the twiner B1 of the liana B as described above, the liana B can maintain its strong engagement with the spiral rope R. As a result, the liana B can not be detached from the spiral rope R and can be promoted to grow upward smoothly.

Further, since the liana B can maintain its strong engagement with the spiral rope R as described above, the liana B is prevented from being detached to drop from the spiral rope R or falling onto the ground before it actually occurs, even if strong wind comes or earthquake occurs. Thus, the growth of the liana B cannot be disturbed.

Further, the winding construction of the side member 20 around the core member 10 is in the spiral construction. Thus, the following effects can be further achieved.

That is, the occurrence of the wind whizzing noise, which is likely to occur in a conventional rope without the spiral structure, can be suppressed. This means that the wind noise, which is likely to occur in the conventional, is significantly reduced by the spiral rope R.

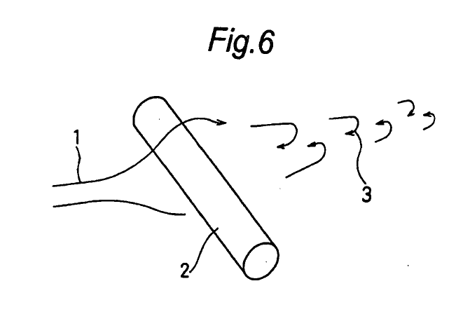

In general, when the wind blows to a round bar 2 from its left side as shown by the arrow 1 in FIG. 6, Karman vortex street 3 occurs at the right side of the round bar 2 located downwind to cause the wind noise.

Contrary to the above, on the assumption that, in FIG. 6, the spiral rope R of the first embodiment is disposed instead of the round bar 2, the occurrence of Karman vortex street downwind of the spiral rope R may be suppressed, since the rope R has the spiral structure as described above. As a result, the occurrence of wind noise can be satisfactorily reduced by the spiral rope R.

The fact that the occurrence of the wind whizzing noise is suppressed means that the spiral rope R has an excellent wind characteristic. Therefore, the force applied to the spiral rope R by the wind pressure can be satisfactorily reduced. As a result, the following effect can be further achieved.

In a wall surface greening system using a plurality of conventional ropes, the ropes have increased tensile strength against tightening fittings thereof in order to resist the wind pressure. Further, since the stretching balance of the ropes is destroyed by the wind pressure, the appearance of the wall surface greening system becomes poor. Therefore, an operation of readjusting the stretched state of the ropes is required. When strong wind blows, especially at the time of typhoon, excessive stretching force is applied to the ropes due to the wind pressure, and as a result, the ropes are detached from the tightening fittings.

Contrary to the above, when the wall surface greening system is constructed by using a plurality of the spiral ropes R as in the first embodiment, there is no need for the spiral ropes R to increase tensile strength against the tightening fittings T, because each spiral rope R has a spiral structure having excellent wind characteristics as described above. Therefore, there is no need for the spiral ropes R to readjust their stretched state. Furthermore, the ropes R can be kept at properly balanced stretched condition, and the appearance of the wall surface greening system can be satisfactorily maintained. At the time of typhoon, the spiral ropes R may not be detached from the tightening fittings T even if the spiral ropes R do not increase tensile strength against the tightening fittings T.

Further, the wall surface greening system exhibits a function of regulating rain water caused by rain in bad weather or drainage to the liana B, and also exhibits a function or operation of uniformly dispersing the water (dispersing function or operation) caused by drainage.

Hereinafter, the function or operation of the wall surface greening system will be described in detail. In the wall surface greening system, a plurality of the spiral ropes R are stretched into the diamond cross pattern. Furthermore, each of the spiral ropes R has the spiral grooves 10a.

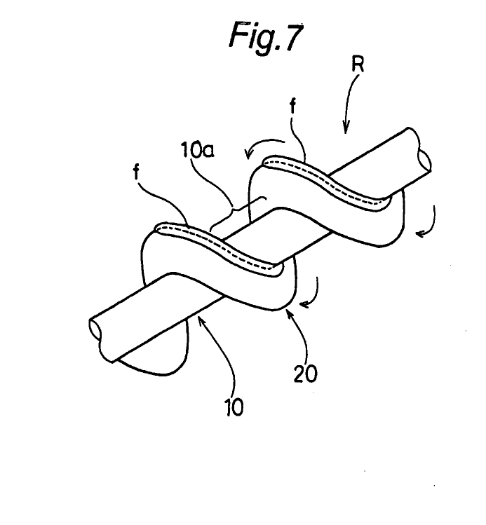

Accordingly, when rain water hits the spiral rope R, the rain water resides, as shown by a reference character f in FIG. 7, within the spiral grooves 10a and becomes a flow of rain water. The flow of rain water flows downstream with its gravity along the spiral grooves 10a as shown by the respective arrows in FIG. 7. This means that the spiral grooves 10a serve as continuous drain ditches and exhibit a function of regulating the flow of rain water. As a result, the flow of rain water is regulated by the spiral grooves 10a and can flow downward without coming out of the spiral grooves 10a.

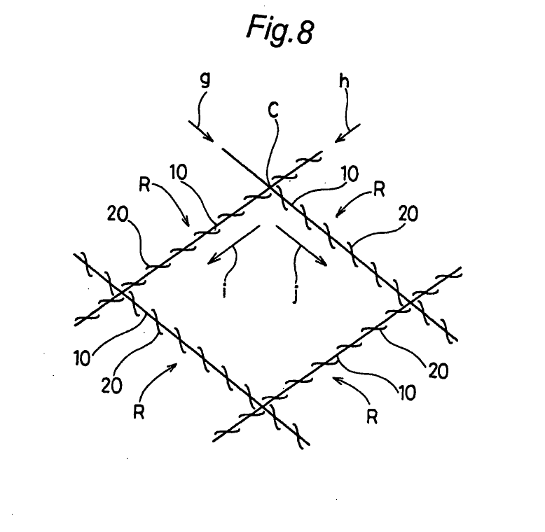

Further, in the wall surface greening system, a plurality of spiral ropes R are stretched into the diamond cross pattern as described above. Thus, the spiral ropes R adjacent to each other exert a diverting function at their crossing portion C (see FIG. 8) to the flow of rain water that flows downward through each of the spiral grooves 10a (see reference characters g and h in FIG. 8) in these adjacent spiral ropes R while being regulated. As a result, the flow of rain water flows downward along the adjacent spiral ropes R as it is regulated and diverted as shown by the arrows i and j (see FIG. 8) at the crossing portion C.

Here, provided that the rain water is to be drained to the liana, the drain water to the entire liana is efficiently and uniformly dispersed by the regulating function and diverging function as described above without causing a specific portion of the water to fall onto the ground.

In addition, if rain water concentrates to one portion, the rain water is not drained sufficiently and thus causes the root of the liana to be easily rotten. Contrarily, the occurrence of the root rot can be properly reduced by the synergy of the regulating function and diverging function as described above.

Further, in the first embodiment, the twisted wire 10 consisting of the core element wire 11 and the side element wires 12 may be made of austenite-based stainless steel wires together with the twisted wire 20 consisting of the core element wire 21 and the side element wires 22. And, the core member 10 and the side member 20 may be respectively formed by elongating an austenite-based stainless steel wire using a predetermined dice and by twisting a plurality of thus-stretched austenite-based stainless steel wires.

Here, the heat conductivity of the austenite-based stainless steel wire is 14 (kcal/m.hr. ° C.), which is about a half of the common carbon steel. Therefore, the austenite-based stainless steel wire is hard to be heated as well as hard to be cooled. In addition, since the core member 10 and the side member 20 respectively consist of twisted wires, they have increased surface areas.

Accordingly, when the irradiation of sunshine is strong in summer, the heat release from the core member 10 and the side member 20 is promoted. As a result, the liana B is satisfactorily prevented from discoloration by heat.

Further, since the outer peripheral surface of each spiral rope R of the first embodiment is convex and spiral based on a stranded structure thereof, the peripheral surface of the spiral rope R is increased in its area. Thus, the heat release from the spiral rope R is promoted and the discoloration of the liana by heat can be further prevented.

In addition, since the austenite-based stainless steel wire as described above is stretched using a dice, the surface of the resultant twisted wire is substantially in a mirror-like status. Thus, the contact angle between a water drop and the surface of the twisted wire (the surfaces of the core member 10 and the side member 20) is small. As a result, the function of draining rain water to the ground can be maintained high.

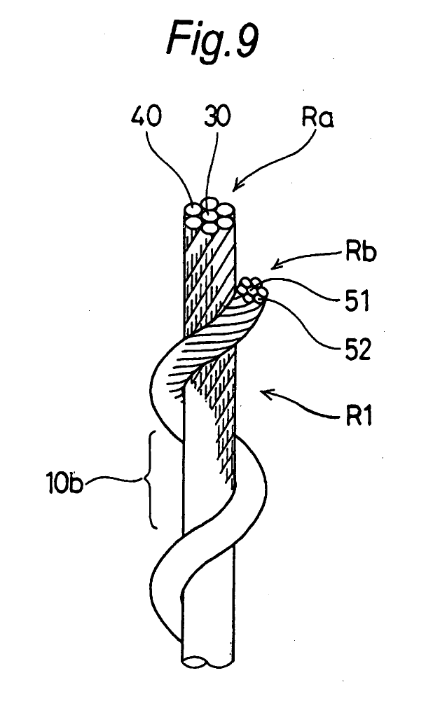

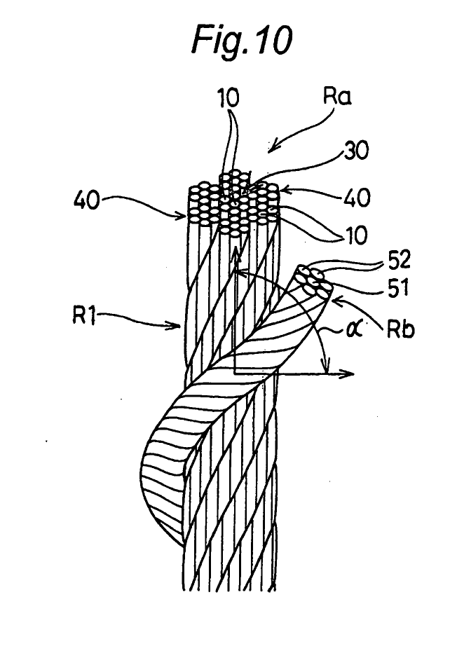

FIGS. 9 and 10 show an essential portion of a second preferred embodiment of the present invention. In the second embodiment, a spiral rope R1 for liana raising is, as shown in FIG. 9, adopted instead of the spiral rope R described in the first embodiment. In addition, as same as the first embodiment, a plurality of the spiral ropes R1 are supported in the diamond cross pattern by a plurality of tightening fittings T in such a manner that they are opposed to the wall surface W, so as to form the wall surface greening system.

Each of the spiral rope R1 includes a core rope member Ra and a side rope member Rb. The side rope member Rb is wound around the core rope member Ra at a predetermined winding pitch (13.8 mm) along the longitudinal direction thereof in the counter-clockwise direction (in the twisting direction in the form of the Z-like shape) (see FIGS. 9 and 10). Accordingly, spiral grooves 10b are formed around the outer periphery of the core rope member Ra.

The core rope member Ra is, as shown in FIG. 10, provided with one bundle of core strand 30 and six bundles of side strands 40 in a 7×7 multi-stranded structure. The core strand 30 is formed as a twisted wire in the form of the Z-like shape with seven (7) of twisted wires, each of which is the core member 10 described in the first embodiment. Additionally, the 7×7 multi-stranded structure means a rope structure in which seven bundles are constructed respectively by a bundle of seven twisted wires and are twisted with each other.

The six bundles of side strands 40 are each formed as a twisted wire in the form of the Z-like shape with seven of twisted wires, each of which is the core member 10 described in the first embodiment.

In the second embodiment, in the core rope member Ra, the outer diameter of the core strand 30 is 0.77 mm, and the outer diameter of the element wire consisting of the core of the core strand 30 is 0.27 mm. The outer diameter of the element wire of the side strand consisting of the side portions of the core strand 30 is 0.25 mm, and the outer diameter of the side strand 40 is 0.66 mm. Further, the outer diameter of the element wire consisting of the core of the side strand 40 is 0.22 mm and the outer diameter of the element wire of the side strand consisting of the side portions of the side strand 40 is 0.22 mm.

As shown in FIG. 10, the side rope member Rb is constructed as a twisted wire in which six side element wires 52 are twisted around one core element wire 51 at a twisting pitch of 6.40 mm in the form of the Z-like shape. In this embodiment, the core element wire 51 and the respective side element wires 52 are made of the austenite-based stainless steel wires described above. In addition, the outer diameter of the side rope member Rb is 0.6 mm. The outer diameters of the core element wire 51 and the respective side element wires 52 of the side rope member Rb are 0.22 mm and 0.20 mm, respectively.

According to the spiral rope R1 constructed as described above, the side rope member Rb is wound around the core rope member Ra at a predetermined cross angle (hereinafter, referred to a cross angle α) given between the twisting direction of the respective side element wires 52 of the side rope member Rb and the twisting direction of the respective side strand 40 of the core rope member Ra.

In the second embodiment, the above-mentioned cross angle α is set into an angle within the range of 90°±10°. The basis of setting the cross angle α into such an angle within the range is as follows.

The twisting direction of each side element wire as a twisted wire of each side strand 40 in the core rope member Ra is substantially perpendicularly crossed to the twisted direction of each side element wire as a twisted wire of the side rope member Rb wound around the core rope member Ra.

A deviation in the winding position of the side rope member Rb against the core rope member Ra may be effectively prevented on a basis of the construction in which the twisting direction of each side element wire as a twisted wire of each side strand 40 in the core rope member Ra is substantially perpendicularly crossed to the twisted direction of each side element wire as a twisted wire of the side rope member Rb wound around the core rope member Ra. Thus, it is most preferable that the cross angle α is 90°.

As a result of further study about the cross angle α, it has been confirmed that the deviation in the winding position of the side rope member Rb against the core rope member Ra can be prevented if the cross angle a is preferably an angle within the range of 90°±10°. For this reason, in the second embodiment, the cross angle α is set to the value described above. Other constructions are the same as those of the first embodiment.

In the second embodiment, in the spiral rope R1, the side rope member Rb is wound around the core rope member Ra in the counter-clockwise direction (in the twisting direction into the Z-like shape) so as to match the winding direction of the twiner B1 of the liana B that grows up in the Northern Hemisphere of the earth. Furthermore, the spiral grooves 10b are formed around the outer periphery of the core rope member Ra.

As a result, the same effects as those achieved by the spiral rope R and the wall surface greening system described in the first embodiment can be also achieved by the spiral rope R1 and the wall surface greening system of the second embodiment.

Further, in the spiral rope R1, the side rope member Rb is wound around the core rope member Ra in such a manner that the twisting direction of each side element wire 52 as a twisted wire of the side rope member Rb constitutes an angle within the range of 90°±10° or substantially a right angle with respect to the twisting direction of each side element wire as a twisted wire of each side strand 40 of the core rope member Ra.

In this embodiment, the direction of the side element wire of each side strand 40 appearing on the outer surface of the core rope member Ra is substantially parallel with the longitudinal direction of the core rope member Ra, and this longitudinal direction crosses substantially at a right angle with the side element wire 52 of the side rope member Rb.

Accordingly, a so-called anchor effect occurs between the side rope member Rb and the core rope member Ra in the spiral rope R1, thereby strongly generating an engagement force of the side rope member Rb against the core rope member Ra. Thus, the deviation in the winding position of the side rope member Rb wound around the core rope member Ra can be assuredly prevented.

As a result, in stretching the spiral rope R1, it becomes possible to stay in the position between the side rope member Rb and the core rope member Ra, even when a wind pressure or an external stretching force is applied to the spiral rope R1 due to trimming or felling of the liana B.

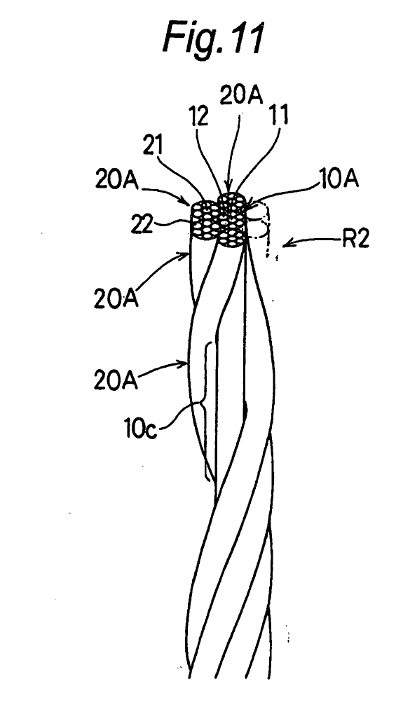

FIG. 11 shows an essential portion of a third preferred embodiment of the present invention. In this third embodiment, a spiral rope R2 for liana raising is adopted instead of the spiral rope R (see FIG. 3) described in the first embodiment. Additionally, a plurality of the spiral ropes R2 are supported into the diamond cross pattern by a plurality of the tightening fittings T, as same as described in the first embedment, in such a manner that they are opposed to the wall surface W to form the wall surface greening system,

The spiral rope R2 consists of multi-stranded ropes with some side strands lacked. In the spiral rope R2, the core member 10 described in the first embodiment is adopted as a core strand 10A of the third embodiment. And also, four (4) twisted wires each of which is the side member 20 of the first embodiment are adopted as four (4) bundles of side strands 20A of this third embodiment.

Here, the spiral rope R2 is formed by using a dedicated stranding machine having a specification in which one bundle of core strand and six bundles of side strands are simultaneously twisted with each together. Thus, to construct the side strands 20A as four bundles means that the spiral rope R2 is formed as a rope with two bundles of side strands lacked (see the circles shown by the double-dotted lines in FIG. 11).

Specifically, the four bundles of the side strands 20A are simultaneously twisted up around the core strand 10A in the form of the Z-like shape at their inherent twisting pitches by using the dedicated twisting machine. Accordingly, spiral grooves 10c are formed around the outer periphery of the core strand 10A so as to correspond to the lacked two bundles of side strands. Other constructions are the same as those of the first embodiment.

In the third embodiment, in the spiral rope R2, four bundles of the side strands 20A are, wound around the core strand 10A in the counter-clockwise direction (in the twisting direction in the form of the Z-like shape) in such a manner that they extend along the winding direction (counter-clockwise direction) of the twiner B1 of the liana B that grows in the Northern Hemisphere of the earth. Furthermore, the spiral grooves 10c are formed around the outer periphery of the core strand 10A as described above (see FIG. 11).

Therefore, the liana B grows, as same as the first embodiment, in such a manner that the twiner B1 winds smoothly around the core strand 10A in the clockwise direction along the spiral grooves 10c. As a result, the same effects as those of the first embodiment can be also achieved in this third embodiment.

Further, as described above, the spiral rope R2 has the structure with two bundles of side strands lacked. Thus, the spiral rope R2 can be manufactured in the same manner as a normal rope, and is suitable for mass production.

Further, as described above, the spiral rope R2 has multi-stranded structure with two bundles of side strands lacked. The surface of the spiral rope R2 becomes a spiral form with larger roughness. Thus, the spiral rope R2 has an increased outer surface area thereof. As a result, the heat release of the spiral rope R2 is promoted to prevent the liana from discoloration by heat.

In the third embodiment, an example has been described in which the spiral rope R2 has a structure with two bundles of side strands lacked. However, the third embodiment is not limited thereto. Even if the spiral rope R2 has a structure with either one or three to five bundles lacked, the substantially same effects as those of the third embodiment can be achieved.

In general, for example, instead of the side strands each having an outer diameter of 2 mm in a multi-stranded structure of 7 bundles×7 wires, the core strand and the respective side strands are simultaneously twisted up into one piece to form the spiral rope R2 in a multi-stranded structure of 5 bundles×7 wires or 4 bundles×7 wires with the number of bundles of side strands reduced by 2 or 3.

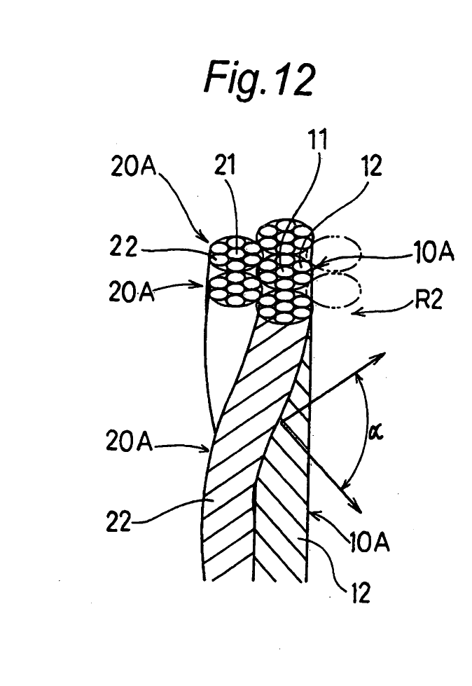

FIG. 12 shows an essential portion of a fourth preferred embodiment of the present invention. In this fourth embodiment, respective side strands 20A are twisted around the core strand 10A in such a manner that all the twisting directions of individual side element wires 22 as twisted wires of each side strand 20A described in the third embodiment create the cross angle α (equal to the angle within the range of 90°±10°) with respect to the twisting directions of individual side element wires 12 as twisted wires of the core strand 10A. Other constructions are the same as those of the third embodiment.

In the fourth embodiment, four bundles of the side strands 20A are twisted around the core strand 10A in such a manner that the twisting directions of individual side element wires 22 as the twisted wires of the side strand 20A create an angle within the range of 90°±10° or substantially a right angle with respect to the twisting directions of individual side element wires 12 as twisted wires of the core strand 10A.

Accordingly, the anchor effect occurs between the individual side strands 20A and the core strand 10A in the spiral rope R2, thereby strongly generating an engagement of the individual side strands 20A with the core strand 10A. Thus, the deviation in the winding position of the individual side strands 20A wound around the core strand 10A can be assuredly prevented.

As a result, in stretching the spiral rope R2, it becomes possible to uniformly stretch the spiral rope R2 with constant tension. And also, no deviation occurs in the position between the respective side strands 20A of the spiral rope R2 and the core strands 10A, even in case of a wind pressure or an external stretching force that is applied to the spiral rope R2 due to trimming or felling of the liana B. Other effects are the same as those of the third embodiment.

When the specifications of the spiral rope R2, the core strand 10A and the individual side strands 20A are selected as shown in Table 1, the cross angle α has been obtained as α=95.2°. In addition, the outer diameters of the core and side element wires of the core strand 10A are set to 0.27 mm and 0.25 mm, respectively.

The outer diameters of the core and side element wires of the side strand 20A are 0.22 mm.

TABLE 1

| | Twisting pitch | Twisting direction |
|---|---|---|
| Spiral rope R2 | 8(mm) | Z |
| Core strand 10A | 3.08(mm) | S |
| Side strand 20A | 2.64(mm) | Z |

In Table 1, the twisting pitch of the spiral rope R2 means a twisting pitch of four bundles of the side strands 20A twisted around the core strand 10A. The twisting pitch of the core strand 10A means a twisting pitch of the six side element wires 12 twisted around the core element wire 11. The twisting pitch of the side strand 20A means a twisting pitch of six side element wires 22 twisted around the core element wire 21.

Since the cross angle α is 95.2° as described above, the cross angle value satisfies an angle within the range of 90°±10°. The deviation in the position of the individual side strands 20A against the core strand 10A can be assuredly prevented.

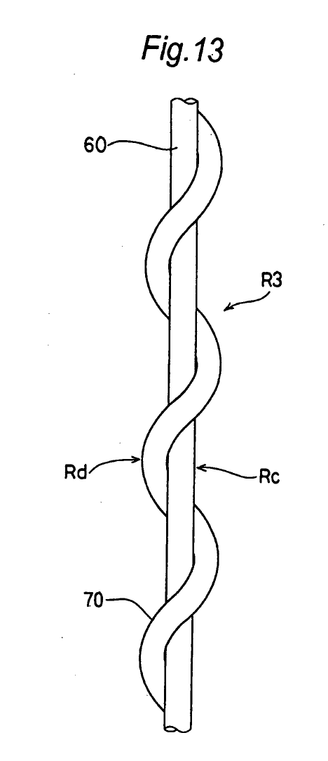

FIGS. 13 shows an essential portion of a fifth preferred embodiment of the present invention. In this fifth embodiment, a spiral rope R3 for liana raising is adopted instead of the spiral rope R described in the first embodiment. A plurality of the spiral ropes R3 is supported into the diamond cross pattern by a plurality of the tightening fittings T, the same as the first embodiment, in such a manner that they are opposed to the wall surface W, so as to form the wall surface greening system.

As shown in FIG. 13, the spiral rope R3 includes a core rope member Rc and a side rope member Rd. The core rope member Rc includes the core member 10 described in the first embodiment, and a core coating layer 60. The core coating layer 60 is formed to cover the core member 10 with a resin material.

The side rope member Rd includes the side member 20 described in the first embodiment, and a side coating layer 70. The side coating layer 70 is formed to coat the side member 20 with a resin material.

In the spiral rope R3, the side rope member Rd is wound around the core rope member Rc along the outer periphery of the core coating layer 60 of the core rope member Rc at a predetermined winding pitch in the counter clockwise direction (in the twisting direction in the form of the Z-like shape) with respect to the core rope member Rc. In addition, the outer diameter of the core rope member Rc (or the core coating layer 60) is 2.4 mm. The outer diameter and winding pitch of the side rope member Rd (or the side coating layer 70) are 1.8 mm and 8.4 mm, respectively. The spiral outer diameter after winding of the side rope member Rd is 5.7 mm.

In the fifth embodiment, an identical or same kind of a resin material is adopted as each of the resin material for forming the core coating layer 60 and the side coating layer 70. This is for preventing the deviation in the winding position of the side rope member Rd against the core rope member Rc, by making impossible slip between the core rope member Rc and the side rope member Rd. In addition, the above mentioned deviation in the winding position corresponds to the deviation in the pitch of the spiral rope R3.

The reason why the deviation of the pitch can be prevented as described above is as follows. By use of the identical or same kind of the resin material as described above, an adhesion phenomenon is created between the core coating layer 60 of the core rope member Rc and the side coating layer 70 of the side rope member Rd wound around the core rope member Rc as described above. As a result, the slippage between the core rope member Rc and the side rope member Rd may be disabled.

In this embodiment, as the identical resin material described above, there are exemplified polyamide, polyvinyl chloride, polyurethane, or polypropylene as forming materials used for both the core coating layer 60 and the side coating layer 70.

Further, as the identical resin material described above, polyamide elastomer material is exemplified as a material for forming either one of the core coating layer 60 and the side coating layer 70, when polyamide is exemplified as a material for forming the remaining of the core coating layer 60 and the side coating layer 70.

Here, a block copolymer of polyamide and polyether is exemplified as the polyamide elastomer material.

When polyamide is exemplified as a material for forming either one of the core coating layer 60 and the side coating layer 70, polyamide added with a plasticizer for imparting flexibility is exemplified as a material for forming as a material for forming the remaining of the core coating layer 60 and the side coating layer 70.

Alternatively, when polypropylene is used as a material for forming either one of the core coating layer 60 and the side coating layer 70 instead of polyamide, polypropylene elastomer material is exemplified as a material for forming the remaining of the core coating layer 60 and the side coating layer 70. There is EPT or EPR as the polypropylene elastomer material.

In addition, polyvinyl chloride added with a plasticizer is exemplified as polyvinyl chloride to be used instead of polyamide, and polyurethane elastomer material is exemplified against polyurethane. As additional information, it is sufficient if the main component of the resin material that forms either one of the core coating layer 60 and the side coating layer 70 is an identical or same kind of material. Other constructions are the same as those of the first embodiment.

In the fifth embodiment both the core coating layer 60 of the core rope member Ra and the side coating layer 70 of the side rope member Rb are made of the identical or same kind of the resin material with each other as described above.

Therefore, an adhesion phenomenon occurs between the core coating layer 60 of the core rope member Rc and the side coating layer 70 of the side rope member Rd wound around the core rope member Rc, thereby being incapable of slipping between the core rope member Rc and the side rope member Rd. Thus, the pitch deviation of the spiral rope R3, namely, the deviation in the winding position of the side rope member Rd against the core rope member Rc can be assuredly prevented.

Further, since both the core coating layer 60 and the side coating layer 70 are made of the resin material, heat conductivities of the core coating layer 60 and the side coating layer 70 are extremely low as compared with metallic wires such as steel wires that constitute the core member 10 and the side member 20.

Here, the core member 10 and the side member 20 are made of twisted wires made of austenite-based stainless steel wires. Further, each outer surface of the core member 10 and the side member 20 is increased, since the outer peripheral surface of the twisted wire becomes the convex spiral shape.

Therefore, the core member 10 and the side member 20 with such respective increased outer surfaces are coated by the core member 10 and the side member 20 as described above, reducing the heat conductivity to the liana. As a result, the discoloration of the liana B based on strong irradiation of sunshine in summer or the like can be significantly reduced according to the spiral rope R3 of the fifth embodiment. As additional information, respective engagement forces between the core member 10 and the core coating layer 60 and between the side member 20 and the side coating layer 70 may be improved by the increased outer surfaces of the core member 10 and the side member 20 described above.

Further, as will be described later, pigment is added to the identical or same kind of resin material described above, thereby obtaining various color tones in the core coating layer 60 and the side coating layer 70.

Further, for increasing the attachment strength between the core rope member Rc and the side rope member Rd, the core rope member Rc may be passed through the adhesive agent applying chamber that contains an adhesive agent and is filled with a pressurized nitrogen gas at an atmospheric pressure or higher. Thus, the adhesive agent adheres over the outer peripheral surface of the core coating layer 60. Thereafter, the side rope member Rd is spirally wound around the core rope member Rc and then is passed through a drying chamber.

Accordingly, the side rope member Rd can firmly adhere to its side coating layer 70 onto the core coating layer 60 of the core rope member Rc. In addition, as the adhesive agent described above, exemplified is an adhesive agent having an isocyanate group at an end thereof, for example, an adhesive agent with the product number GF-100A B that is produced by Sakai Chemical Industrial Co., Ltd in Japan.

Further, in the fifth embodiment, the deviation in the winding position of the side rope member Rd against the core rope member Rc can be further assuredly prevented in cooperation with the adhesion phenomenon between the core coating layer 60 and the side coating layer 70, if the twisting direction of the respective side element wires as the twisted wires of the side member 20 of the side coating layer 70 creates the cross angle α (equal to an angle within the range of 90°±10°) with respect to the twisting direction of the respective side element wires as the twisted wires of the core member 20, as is substantially the same as the second embodiment. Other effects are the same as those of the first embodiment.

Next, a sixth preferred embodiment of the present invention will be described. The sixth embodiment is proposed under the following premise as an example for being applied to the fifth embodiment described above.

In general, the color tone of the outer surface of the spiral rope that is used in the wall surface greening system of the present invention or the conventional wall surface greening system is hard to satisfy a fitting condition to circumferential color tones. Herein, as the circumferential color tones, are exemplified the color tone of the twiners, leaves, flowers of the liana growing along the wall surface greening system, and the color tone of the wall surface becoming a background of the wall surface greening system.

If the above mentioned fitting condition to circumferential color tones is not satisfied, the rope becomes conspicuous and impairs the appearance of the wall surface greening system. Accordingly, it is desirable that the color tone of the outer surface of the spiral rope in the present invention can satisfy the above mentioned fitting condition to circumferential color tones.

For this, if the coloring easiness of the resin material is utilized, the color tone of at least one of the core coating layer 60 and the side coating layer 70 described in the fifth embodiment can be assimilated with the color tone of the twiners, leaves and flowers of the liana or the color tone of the wall surface that is the background of the wall surface greening system.

Here, the assimilation means that the color tone of at least one of the core coating layer 60 and the side coating layer 70 is matched with the color tone of the twiners, leaves or flowers of the liana or the color tone of the wall surface that becomes the background of the wall surface greening system. The assimilation is one example that satisfies the above mentioned fitting condition to circumferential color tones.

Thus, in the sixth embodiment, it is set to achieve the color tone of at least one of the core coating layer 60 and the side coating layer 70 is assimilated with the color tone of the twiners, leaves or flowers of the liana of the color tone of the wall surface as the background, thereby maintaining an excellent appearance of the wall surface greening system.

In this sixth embodiment, the color tone of at least one of the core coating layer 60 and the side coating layer 70 described in the fifth embodiment is assimilated with the color tone of the twiners and leaves of the liana or the wall surface which is the background.

Specifically, taking into consideration the color tone of the twiner B1 and the leaves B2 of the liana B (see FIG. 2) or the color tone of the wall surface W which is the background, the color tone of at least one of the core coating layer 60 and the side coating layer 70 is arranged into a dot design, a grain design or a pebble-like design, thereby realizing the above described assimilation.

For example, when the color tone of the twiner B1 of the liana B is in a light green color, the color tone of at least one of the core coating layer 60 and the side coating layer 70 is arranged into a dotted design including a large number of green dots on a white base material.

Thus, the color tone of at least one of the core coating layer 60 and the side coating layer 70 combines both the green colors of the twiner B1 and leaves B2 of the liana B and can be assimilated with the color tone of the liana B. As additional information, for example, although the color tone of the leaves of the liana is green, all the leaves are not of identical brightness and saturation, but these combine with each other to create dark green portions and other portions. In such a case, the dotted design serves to achieve the assimilation.

Further, when the color tone of the twiner B1 of the liana B is dark brown, the color tone of at least one of the core coating layer 60 and the side coating layer 70 is arranged into brown grain design. Thus, the color tone of at least one of the core coating layer 60 and the side coating layer 70 can be assimilated with the color tone of the twiner B1 of the liana B.

As the liana B grows up, the leaves B2 of the liana B grow into large sizes. Thus, the spiral ropes R3 are behind the leaves B2. However, in the early stage after the liana B is planted, the spiral ropes R3 of the wall surface greening system, which are stretched into the diamond cross pattern, are exposed to the outside. Accordingly, the spiral ropes R3 are conspicuous in contrast to the wall surface W as the background.

At this time, when the wall surface W is in, for example, a marble-like design, at least one of the core coating layer 60 and the side coating layer 70 is provided with a pebble-like design. Thus, the pebble-like design, which is in the color tone of at least one of the core coating layer 60 and the side coating layer 70, can be assimilated with the marble-like design. Especially, some kinds of lianas take one or more years to reach the higher floors of the building. Therefore, the marble-like design is preferable when the lianas taking a long time to grow up are used for greening the wall surfaces at higher floors of the building.

Next, in the spiral rope R3 described in the fifth embodiment, the spiral rope R3 is manufactured as follows, for imparting the assimilating color tone described above to at least one of the core coating layer 60 and the side coating layer 70.

(1) First Manufacturing Method

The core member 10 and the respective side members 20 are manufactured in the same manner as described in the fifth embodiment. Further, a resin material having different molecular structures is colored, and the colored resin material is mixed with the resin material described in the fifth embodiment (an identical or same kind of resin material described above) so as to prepare the first colored resin material for assimilation.

Then, at least one of the core coating layer 60 and the side coating layer 70 is molded by the first colored resin material for assimilation so as to cover at least one of the core member 10 and the side member 20, thereby manufacturing the core rope member Rc and the side rope member Rd. In addition, the remaining one of the core member 10 and the side member 20, which is not covered with the first colored resin material for assimilation, is covered with the resin material described in the fifth embodiment (the identical or same kind of resin material).

Next, the side rope member Rd is spirally wound around the core rope member Rc at intervals in the longitudinal direction in the same manner as described in the fifth embodiment. At this stage, the side rope member Rd is wound around the core rope member Rc in such a manner that the winding direction of the side rope member Rd around the core rope member Rc coincides with the winding direction of the twiner (B1) of the liana (B) that grows in the Northern Hemisphere of the earth.

As described above, the spiral rope of the sixth embodiment can be manufactured by covering at least one of the core coating layer 60 and the side coating layer 70 of the spiral rope R3 described in the fifth embodiment with the first colored resin material for assimilation.

By stretching thus-manufactured spiral rope over the wall surface greening system, not only the effects described in the fifth embodiment can be naturally achieved but also the color tone of at least one of the core coating layer 60 and the side coating layer 70 can be assimilated with the color tone of the liana. As a result, the spiral rope manufactured in the sixth embodiment is not conspicuous against the liana.

(2) Second Manufacturing Method

The core member 10 and the respective side members 20 are manufactured in the same manner as above. Further, colored resin material with different melt index (MI) is mixed with the resin material described in the fifth embodiment (the identical or same kind of resin material) so as to prepare a second colored resin material for assimilation. Then, at least one of the core coating layer 60 and the side coating layer 70 is molded with the second colored resin material for assimilation in such a manner that at least one of the core member 10 and the respective side members 20 is covered, thereby manufacturing the core rope member Rc and the side rope member Rd. In addition, the remaining one of the core member 10 and the side members 20, which is not covered with the second colored resin material for assimilation, is covered with the resin material described in the fifth embodiment (the identical or same kind of resin material). The steps and effects other than described above are the same as those described for the first manufacturing method.

(3) More specifically, there are the following manufacturing methods.

(a) Method for Imparting a Dot Pattern

A plastic resin material or elastomer, which cross-links with an organic oxide, is blended with a coloring pigment and an organic peroxide. Then, at least one of the core member 10 and the side member 20 is molded to be covered with the resultant blend, thereby manufacturing at least one of the core rope member Rc and the side rope member Rd. Thus, at least one of the core coating layer 60 of the core rope member Rc and the side coating layer 70 of the side rope member Rd can express a dotted pattern on its outer surface.

(b) Method for Imparting a Grain Design

A high density polyethylene with a melt index of 5 or lower is mixed with inorganic powder and a coloring agent so as to prepare a coloring agent composition. Then, the coloring agent composition is added to an olefin-based resin material. Subsequently, at least one of the core member 10 and the side members 20 is molded to be covered with the resultant mixed composition, thereby manufacturing at least one of the core rope member Rc and the side rope member Rd. Thus, at least one of the core coating layer 60 and the side coating layer 70 can express a grain design on its outer surface.

(c) Method for Imparting a Pebble-Like Design

A proper amount of a normal thermoplastic resin with no cross-linking reactivity is added to a coloring agent with a small melt index and a high melting point, or the blended agent adopted in the method for imparting the dot pattern. Then, at least one of the core member 10 and the side members 20 is molded to be coated with the mixed agent of which mixing rate is adjusted, thereby manufacturing at least one of the core rope member Rc and the side rope member Rd. Thus, at least one of the core coating layer 60 and the side coating layer 70 can express a pebble-like design appears to be pebbles flow. Other constructions and effects are the same as those described in the fifth embodiment.

Next, a seventh preferred embodiment of the present invention will be described. This seventh embodiment is proposed under the following premise, as an example for being applied to the fifth embodiment.

In this seventh embodiment, by utilizing the coloring easiness of the resin material described in the sixth embodiment, it is set to achieve that unlike the assimilation described in the sixth embodiment, a color tone of at least one of the core coating layer 60 and the side coating layer 70 is arranged into a color tone in a complementary color contrast with respect to the color tone of the twiners, leaves, or flowers of the liana or the color tone of the wall surface as the background of the wall surface greening system, thereby maintaining the good appearance as the wall surface greening system. Additionally, the complementary color contrast is another example of satisfying the fitting condition to the circumferential color tones described in the sixth embodiment.

Thus, in the seventh embodiment, the color tone of at least one of the core coating layer 60 and the side coating layer 70 described in the fifth embodiment is brought into the color tone in the complementary color contrast with respect to the color tone of the liana B or the color tone of the wall surface W as the background of the wall surface greening system.

Specifically, at least one of the color tone of the core coating layer 60 and the side coating layer 70 is brought into the color tone in the complementary color contrast with respect to the color tone of the flowers of the liana B.

For example, if the color of the flowers of the liana B is “red”, the color tone of at least one of the core coating layer 60 and the side coating layer 70 is set to “green”. Thus, clearer red color can be presented. This is given by the reason why “red” and “green” are opposite colors to each other in a hue circle, and are in a complementary color contrast relationship with each other.

Further, the color tone of at least one of the core coating layer 60 and the side coating layer 70 may be arranged into either one of a dot design, a grain design and a pebble-like design as same as that in the sixth embodiment. In this case, it is sufficient for the color tone of at least one of the core coating layer 60 and the side coating layer 70 to be in a complementary color contrast relationship with the color either one or both of whose brightness and color saturation are higher.

Next, in the spiral rope R3 described in the fifth embodiment, the spiral rope R3 is manufactured in either one of the following methods, for imparting the color tone in the complementary color contrast relationship to at least one of the core coating layer 60 and the side coating layer 70.

(1) First Manufacturing Method

A first manufacturing method of the seventh embodiment differs from the first manufacturing method described in the sixth embodiment in which at least one of the core member 10 and the side member 20 is molded to be coated with a first colored resin material for complementary color contrast, instead of the first colored resin material for assimilation.

Herein, the above mentioned first colored resin material for complementary color contrast is manufactured by a process that a colored resin material obtained by coloring a resin material with a different composition is mixed with the resin material (the identical or same kind of resin material) described in the fifth embodiment.

According to this method, unlike the color tone resulted from assimilation described above, a color tone in a complementary color contrast relationship with the color tone of the flowers of the liana B can be achieved in either one of the core coating layer 60 and the side coating layer 70. As a result, the spiral rope manufactured in this seventh embodiment is not conspicuous against the liana B. Other constructions and effects are the same as those of the fifth embodiment.

(2) Second Manufacturing Method

A second manufacturing method of the seventh embodiment differs from the first manufacturing method described above in which at least one of the core member 10 and the side member 20 is molded to be coated with a second colored resin material for complementary color contrast, instead of the first colored resin material for assimilation described above.

Herein, the above mentioned second colored resin material for complementary color contrast is manufactured by a process that a colored resin material for complementary color contrast with different melt index (MI) is mixed with the resin material described in the fifth embodiment.

Accordingly, the same effects as those of the first manufacturing method described above can be achieved.

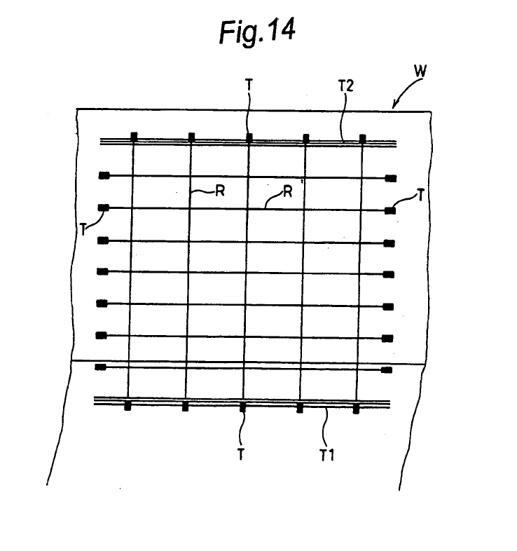

FIG. 14 shows an eighth embodiment of the present invention. In the eighth embodiment, a wall surface greening system as shown in FIG. 14 is adopted instead of the wall surface greening system described in the first embodiment.

The wall surface greening system of this eighth embodiment is supported between the upper portion of the wall surface W and the ground in such a manner that a plurality of the spiral ropes R for liana raising described in the first embodiment are stretched by a plurality of tightening fittings T and opposite tightening bars T1 and T2. Other constructions are the same as those of the first embodiment.

According to the eighth embodiment, the same effects as those of the first embodiment can be achieved except for the diverging effect.

The wall surface greening system of the eighth embodiment is not limited to the wall surface greening system described in the first embodiment, but alternatively may be adopted instead of the wall surface greening system described in any one of the second to seventh embodiments.

According to the above, the effects described in either one of the second to seventh embodiments can be achieved except for the diverging effect.

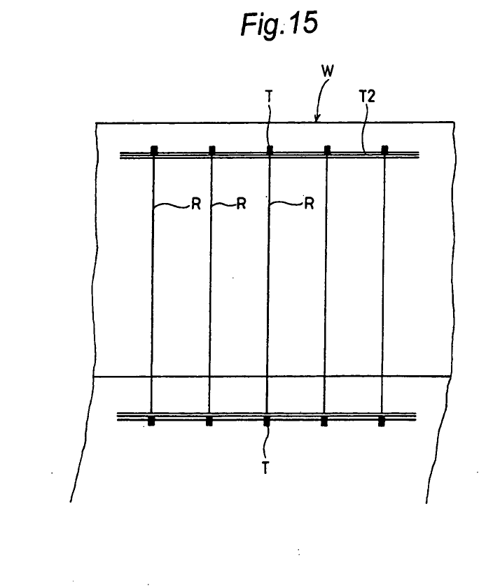

FIG. 15 shows a ninth preferred embodiment of the present invention. In this ninth embodiment, a wall surface greening system as shown in FIG. 15 is adopted instead of the wall surface greening system described in the first embodiment.

The wall surface greening system of the ninth embodiment is supported between the upper portion of the wall surface W and the ground in such a manner that a plurality of the spiral ropes R for liana raising described in the first embodiment is stretched by a plurality of tightening fittings T and opposite tightening bars T1 and T2 so as to be inclined with respect to the wall surface W in a straight pattern. Other constructions are the same as those of the first embodiment.

According to the ninth embodiment as constructed above, the effects described in the first embodiment can be achieved except for the diverging effect.

In addition, the wall surface greening system of the ninth embodiment is not limited to the wall surface greening system described in the first embodiment, but may be adopted instead of the wall surface greening system described in any one of the second to seventh embodiment.

According to the above, the effects described in any one of the second to seventh embodiments can be achieved except for the diverging effect.

In carrying out the present invention, it is not specifically limited to the embodiments described above, but the following various modifications may be exemplified.

(1) Each of the foregoing embodiments is described on the premise that the liana grows in the Northern Hemisphere in the earth. Instead, for the liana that grows up in the Southern Hemisphere in the earth, the side member (the side member 20, the side rope member Rb or the side rope member Rd) is wound around the core member (the core member 10, the core rope member Ra or the core rope member Rc) in the clockwise direction, when seen from the top end portion of the twiner along its growth, in such a manner that the winding direction of the side member around the core member coincides with the winding direction of the twiner of the liana that grows in the Southern Hemisphere in the earth (see FIG. 5).

In this manner as well, the substantially same effects as those described in the foregoing embodiments can be achieved. The same thing is applied to the twisting direction of the side member (the side strand 20A) around the core member (the core strand 10A).

(2) In the first embodiment, the individual side element wires as twisted wires of the side member 20 may be twisted in the direction which creates a cross angle a with respect to the twisting direction of the individual side element wires as the twisted wires of the core member 10. In this manner as well, the same effects as those described in the second embodiment can be achieved.

(3) In the seventh embodiment, the color tones in the complementary color contrast relationship are not limited to red and green. Alternatively, for example, the color tones may be purple and yellow. In general, color tones may be in any colors that are in a relationship totally opposite to each other in a hue circle.

What is claimed is:

1. A wall surface greening system in which ropes are provided on a wall surface, each of said ropes comprising a core member, around which a side member is spirally wound along a longitudinal direction of said core member so as to grow a twiner of a liana around an outer surface of said core member along said side member;
a plurality of said ropes being arranged in a stretched condition to form a diamond cross pattern as a whole.

2. A wall surface greening system in which ropes are provided on a wall surface, each of said ropes comprising a core member, around which a side member is spirally wound along a longitudinal direction of said core member so as to grow a twiner of a liana around an outer surface of said core member along said side member;
a plurality of said ropes are divided into two groups, one of said two groups arranged along one direction and the other group arranged along a direction other than said one direction so as to form a diamond cross pattern as a whole.

3. A wall surface greening system in which ropes are provided on a wall surface, each of said ropes comprising a core rope member and a side rope member, said side rope member being spirally wound around said core rope member along a longitudinal direction of said core rope member so as to grow a twiner of a liana around an outer surface of said core rope member;
said core rope member having one bundle of core strands and a plurality of bundles of side strands spirally wound around said one bundle of said core strands;
said side rope member having core element wire and side element wires twisted around said core element wire;
said core strands of said core rope member being parallel with a longitudinal direction of said core rope member and crossing at an angle of 90±10 degrees with said side element wires of said side rope member.

4. The wall surface greening system according to claim 1, wherein said side member serves as a plurality of bundles of side strands which are wound around said core member with some of said bundles of said side strands lacked, so as to form a spiral groove along the lacked bundles of said side strands for extending said twiner of said liana.

5. The wall surface greening system according to claim 4, wherein said core member serves as core strand comprising a core element wire and side element wires each twisted around said core element wire, and said side strands having a core element wire and side element wires each twisted around said core element wire, and twisting directions of said side element wires of said core element forms 90±10 degrees with respect to twisting directions of said side element wires of said bundles of said side strands.

6. The wall surface greening system according to claim 1 or 2, wherein said core member and said side member are each formed from twisted wires of austenite-based stainless steel, each outer surface of said core member and said side member is covered with a coating layer of a resin material.
